(19) United States
(12) Patent Application Publication
(10) Pub. No.: US 2007/0087711 A1
(43) Pub. Date: Apr. 19, 2007

(54) Multiple band transceiver

(75) Inventor: Meng-An Pan, Irvine, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/252,788

(22) Filed: Oct. 19, 2005

(51) Int. Cl. H04B 1/04

(52) U.S. Cl. 455/127.4; 455/118

(57) ABSTRACT

A frequency translation apparatus provides selective frequency translation of an input signal with reduced distortion effects. The frequency translation apparatus includes a plurality of mixers. Each mixer is coupled to the input signal and to a corresponding local oscillator (LO) signal. The frequency translation apparatus further includes a plurality of bias networks corresponding to the plurality of mixers. Each bias network produces a bias voltage for a corresponding mixer. A mixer is deactivated by providing an LO input of a mixer to a corresponding bias voltage. A mixer is activated by not providing the LO input of the mixer to the corresponding bias voltage. An activated mixer subsequently frequency translates the input signal according to the corresponding LO signal to produce a corresponding output signal.

### BACKGROUND OF THE INVENTION

1. Field of the Invention

The present invention generally relates to frequency translation of input signals to produce output signals. More specifically, the present invention provides selective frequency translation with reduced distortion effects.

2. Background Art

Generally, a radio frequency (RF) transmitter up-converts a baseband input signal to produce an RF output signal. The RF output signal resides on a single RF band of operation. A multi-band RF transmitter, however, selectively up-converts the baseband input signal onto one or more RF bands. Similarly, a multi-band RF receiver selectively down-converts one or more RF input signals residing on separate RF bands to produce one or more baseband output signals.

Typically, a multi-band transmitter and a multi-band receiver use a switch box to selectively up-convert and down-convert input signals, respectively. The switch box routes the input signals to appropriate mixers for desired frequency translation. The switch box, however, adds distortion to the input signals and reduces voltage headroom. Further, implementing the switch box requires additional components. As a result, the switch box increases manufacturing and design costs while occupying a large amount of area when realized on a chip.

### BRIEF SUMMARY OF THE INVENTION

Accordingly, the present invention provides selective frequency translation of an input signal with reduced distortion and loss of voltage headroom.

In one embodiment, a frequency translation apparatus provides selective frequency translation of an input signal. The frequency translation apparatus includes a plurality of mixers. Each mixer is coupled to the input signal and to a corresponding local oscillator (LO) signal. The frequency translation apparatus further includes a plurality of bias networks corresponding to the plurality of mixers. Each bias network produces a bias voltage for a corresponding mixer. A mixer is deactivated by decoupling or removing an LO input of a mixer from a corresponding bias voltage. A mixer is activated by coupling or providing the LO input of the mixer to the corresponding bias voltage. An activated mixer subsequently frequency translates the input signal according to the corresponding LO signal to produce a corresponding output signal. A controller can control the activation and deactivation of mixers.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

FIG. 1 illustrates a conventional wireless transmitter.

FIG. 2 illustrates a configuration of a conventional switch depicted in FIG. 1.

FIG. 3 illustrates a wireless transmitter of the present invention.

FIG. 4 illustrates a biasing arrangement of a first mixer and a second mixer depicted in FIG. 3 in accordance with an aspect of the present invention.

FIG. 5 provides a flowchart that illustrates operational steps for selectively frequency translating an input signal in accordance with an aspect of the present invention.

### DETAILED DESCRIPTION OF THE INVENTION

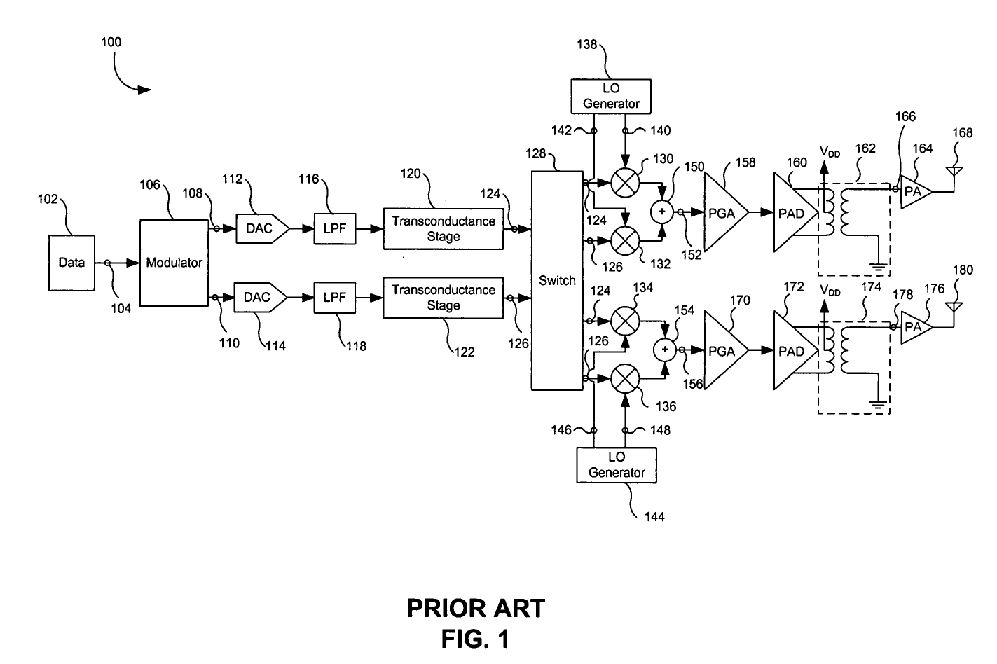

FIG. 1 illustrates a conventional wireless transmitter 100. The conventional wireless transmitter 100 includes an information source 102. The information source 102 generates a data signal 104. The data signal 104 is a sequence of bits. The information source 102 provides the data signal 104 to a modulator 106. The modulator 106 encodes and modulates the data signal 104 and provides two modulation channels (e.g., an in-phase channel and a quadrature-phase channel). Specifically, the modulator 106 generates a modulated data signal 108 and an associated modulated data signal 110. The modulated data signals 108 and 110 can be baseband signals or can be signals centered at an intermediate frequency (IF). The modulated data signals 108 and 110 can be considered in-phase and quadrature-phase information signals, respectively. At the output of the modulator 106, the modulated data signals 108 and 110 are multiple-bit digital signals.

As illustrated in FIG. 1, the modulated data signals 108 and 110 are provided to digital-to-analog converters (DACs) 112 and 114 and to low-pass filters (LPFs) 116 and 118, respectively. The DAC 112 converts the modulated data signal 108 from a digital signal into a differential analog signal. The LPF 116 isolates an appropriate portion of the modulated data signal 108 for transmission. Similarly, the DAC 114 converts the modulated data signal 110 from a digital signal to a differential analog signal and the LPF 118 isolates an appropriate portion of the modulated data signal 110 for transmission.

A transconductance stage 120 converts the modulated data signal 108 from a differential voltage signal into a differential current signal. Likewise, a transconductance stage 122 converts the modulated data signal 110 from a differential voltage signal into a differential current signal. The modulated data signal 108, after processing by the DAC 112 and the LPF 116 and conversion by the transconductance stage 120, can be considered a processed modulated signal 124. Likewise, the modulated data signal 110, after processing by the DAC 114 and the LPF 118 and conversion by the transconductance stage 122, can be considered a processed modulated signal 126.

As further illustrated in FIG. 1, the processed modulated signals 124 and 126 are fed to a conventional switch or switch box 128. The conventional switch 128 switches or routes the processed modulated signals 124 and 126 between two pairs of mixers. A mixer 130 and a mixer 132 form the first pair of mixers. A mixer 134 and a mixer 136 form the second pair of mixers. The mixers 130 and 132 are coupled to a local oscillator (LO) generator 138. The LO generator 138 generates an in-phase LO signal 140 and a quadrature-phase LO signal 142. An LO input of the mixer 130 receives the in-phase LO signal 140. An LO input of the mixer 132 receives the quadrature-phase LO signal 142. The in-phase LO signal 140 and the quadrature-phase LO signal 142 are typically high frequency signals. For example, the in-phase LO signal 140 and the quadrature-phase LO signal 142 can be radio frequency (RF) signals. Further, the in-phase LO signal 140 and the quadrature-phase LO signal 142 approximately have the same frequency (i.e., a first LO frequency,ƒ_{LO,1}).

The mixers 134 and 136 are coupled to a local oscillator (LO) generator 144. The LO generator 144 generates an in-phase LO signal 146 and a quadrature-phase LO signal 148. An LO input of the mixer 134 receives the in-phase LO signal 146. An LO input of the mixer 136 receives the quadrature-phase LO signal 148. The in-phase LO signal 146 and the quadrature-phase LO signal 148 are also typically high frequency signals. For example, the in-phase LO signal 146 and the quadrature-phase LO signal 148 can be radio frequency (RF) signals. Further, the in-phase LO signal 146 and the quadrature-phase LO signal 148 approximately have the same frequency (i.e., a second LO frequency,ƒ_{LO,2}).

The conventional switch 128 provides the processed data signal 124 to either a signal input of the mixer 130 or to a signal input of the mixer 134.

Further, the conventional switch 128 provides the processed modulated signal 126 to either a signal input of the mixer 132 or to a signal input of the mixer 136. In this way, the processed modulated signals 124 and 126 are provided as an input signal pair to either the first pair of mixers or to the second pair of mixers.

When the mixers 130 and 132 receive the processed data signals 124 and 126, respectively, the mixer 130 uses the in-phase LO signal 140 to up-convert the processed modulated signal 124 to a higher frequency. Specifically, the mixer 130 receives the processed modulated signal 124 as a differential analog signal and produces a frequency-translated version of the processed modulated signal 124 that is also a differential analog signal. Similarly, the mixer 132 uses the quadrature-phase LO signal 142 to up-convert the processed modulated signal 126 to a higher frequency. The mixer 132 receives the processed modulated signal 126 as a differential analog signal and produces a frequency-translated version of the processed modulated signal 126 that is also a differential analog signal. In this way, the processed modulated signals 124 and 126 are up-converted to a first RF frequency (i.e.,ƒ_{RF,1}) or band by the mixers 130 and 132, respectively.

When the mixers 134 and 136 receive the processed data signals 124 and 126, respectively, the mixer 134 uses the in-phase LO signal 146 to up-convert the processed modulated signal 124 to a higher frequency. Specifically, the mixer 134 receives the processed modulated signal 124 as a differential analog signal and produces a frequency-translated version of the processed modulated signal 124 that is also a differential analog signal. Similarly, the mixer 136 uses the quadrature-phase LO signal 148 to up-convert the processed modulated signal 126 to a higher frequency. The mixer 136 receives the processed modulated signal 126 as a differential analog signal and produces a frequency-translated version of the processed modulated signal 126 that is also a differential analog signal. In this way, the processed modulated signals 124 and 126 are up-converted to a second RF frequency (i.e.,ƒ_{RF,2}) or band by the mixers 134 and 136, respectively.

As further illustrated in FIG. 1, the outputs of the mixers 130 and 132 are provided to an inverting summer 150. The inverting summer 150 subtracts the differential components of the differential analog signal produced by the mixer 132 from the corresponding differential components of the differential analog signal produced by the mixer 130. In other words, the inverting summer 150 sums the output of the mixer 130 with an inverted version of the output of the mixer 132. As a result, the inverting summer 150 produces a first up-converted modulated signal 152. The first up-converted modulated signal 152 is a differential signal.

The outputs of the mixers 134 and 136 are similarly configured. Specifically, the outputs of the mixers 134 and 136 are provided to an inverting summer 154. The inverting summer 154 subtracts the differential components of the differential analog signal produced by the mixer 136 from the corresponding differential components of the differential analog signal produced by the mixer 134. In other words, the inverting summer 154 sums the output of the mixer 134 with an inverted version of the output of the mixer 136. As a result, the inverting summer 154 produces a second up-converted modulated signal 156. The second up-converted modulated signal 156 is a differential signal.

The first up-converted modulated signal 152 and the second up-converted modulated signal 156 are each generated by up-converting or frequency translating the processed data signals 124 and 126. However, the processed modulated signals 124 and 126 are frequency translated by different amounts (i.e., ƒ_{LO,1}≠ƒ_{LO,2}) to produce either the first or second up-converted modulated signals 152 and 156. Consequently, the first and second modulated signals 152 and 156 are of different frequencies (i.e., reside on different frequency bands).

The inverting summer 150 is coupled to a programmable gain amplifier (PGA) 158. The PGA 158 amplifies the first up-converted modulated signal 152. The gain of the PGA 158 is typically programmable, or variable, and so can be adjusted during operation of the conventional wireless transmitter 100. The PGA 158 is coupled to a power amplifier driver (PAD) 160. The PAD 160 also amplifies the first up-converted modulated signal 152. The gain of the PAD 160 is typically fixed and so cannot be adjusted during operation of the conventional wireless transmitter 100.

The PAD 160 provides the amplified first up-converted modulated signal 152 to the primary winding of a transformer 162. The primary winding of the transformer 162 has two taps for differentially receiving the amplified first up-converted modulated signal 152. A middle primary winding tap is coupled to a power supply V_{DD}. The secondary winding of the transformer 162 has two taps. A first secondary winding tap is coupled to a power amplifier (PA) 164. A second secondary winding tap is coupled to a ground. The transformer 162 converts the differential output of the PAD 160 into a first single-ended output signal 166. The first single-ended output signal 166 is provided to the PA 164. The PA 164 amplifies the first single-ended output signal 166. An amplified version of the first single-ended output signal 166 is provided to an antenna 168 for wireless transmission.

The inverting summer 154 is also coupled to a PGA 170. The PGA 170 amplifies the second up-converted modulated signal 156. The gain of the PGA 170 is typically programmable, or variable, and so can be adjusted during operation of the conventional wireless transmitter 100. The PGA 170 is coupled to a PAD 172. The PAD 172 also amplifies second up-converted modulated signal 156. The gain of the PAD 172 is typically fixed and so cannot be adjusted during operation of the conventional wireless transmitter 100.

The PAD 172 provides the amplified second up-converted modulated signal 156 to the primary winding of a transformer 174. The primary winding of the transformer 174 has two taps for differentially receiving the amplified second up-converted modulated signal 156. A middle primary winding tap is coupled to the power supply V_{DD}. The secondary winding of the transformer 174 has two taps. A first secondary winding tap is coupled to a PA 176. A second secondary winding tap is coupled to a ground. The transformer 174 converts the differential output of the PAD 172 into a second single-ended output signal 178. The second single-ended output signal 178 is provided to the PA 176. The PA 176 amplifies the second single-ended output signal 178. An amplified version of the second single-ended output signal 178 is provided to an antenna 180 for wireless transmission.

The conventional wireless transmitter 100 can be a generalized in-phase/quadrature-phase transmitter. Specifically, the conventional wireless transmitter 100 can be adapted to provide various types of modulated data signals 108 and 110 by implementing a variety of modulation schemes with the modulator 106. Further, the conventional wireless transmitter 100 can be adapted to up-convert the processed modulated signals 124 and 126 onto a variety of transmission channel bandwidths by altering the LPFs 116 and 118, the in-phase LO signals 140 and 146 and the quadrature-phase LO signals 142 and 148. Overall, the conventional wireless transmitter 100 can be modified to provide a transmitter output signal (i.e., either the first single-ended output signal 166 or the second single-ended output signal 178) that conforms to a variety of communication protocols, standards, or known schemes.

The conventional wireless transmitter 100 can be implemented, for example, as a Institute of Electrical and Electronics Engineers (IEEE) 802.11a/b/g transmitter. In effect, the conventional wireless transmitter 100, as a 802.11a/b/g transmitter, operates as a multi-mode (i.e., multiple modulation schemes supported), multi-band transmitter. The conventional wireless transmitter 100 adjusts the modulation of the data signal 104 and the up-conversion of the processed modulated signals 124 and 126 based on specific transmitter operation.

During 802.11b or 802.11g operation, the conventional switch 128 routes the processed modulated signals 124 and 126 to the mixers 130 and 132. The mixers 130 and 132 and the LO generator 138 subsequently up-convert the processed modulated signals 124 and 126 to approximately 2.4 GHz (i.e., the B/G band). During 802.11a operation, the conventional switch 128 routes the processed modulated signals 124 and 126 to the mixers 134 and 136. The mixers 134 and 136 and the LO generator 144 subsequently up-convert the processed modulated signals 124 and 126 to approximately 5 GHz (i.e., the A band).

Operation of the DACs 112 and 114, the LPFs 116 and 118 and the modulator 106 are adjusted to generate the processed modulated signals 124 and 126 in accordance with a particular IEEE standard. Overall, the conventional wireless transmitter 100 uses the conventional switch 128 to provide selective transmission of baseband or IF signals over multiple RF frequency bands.

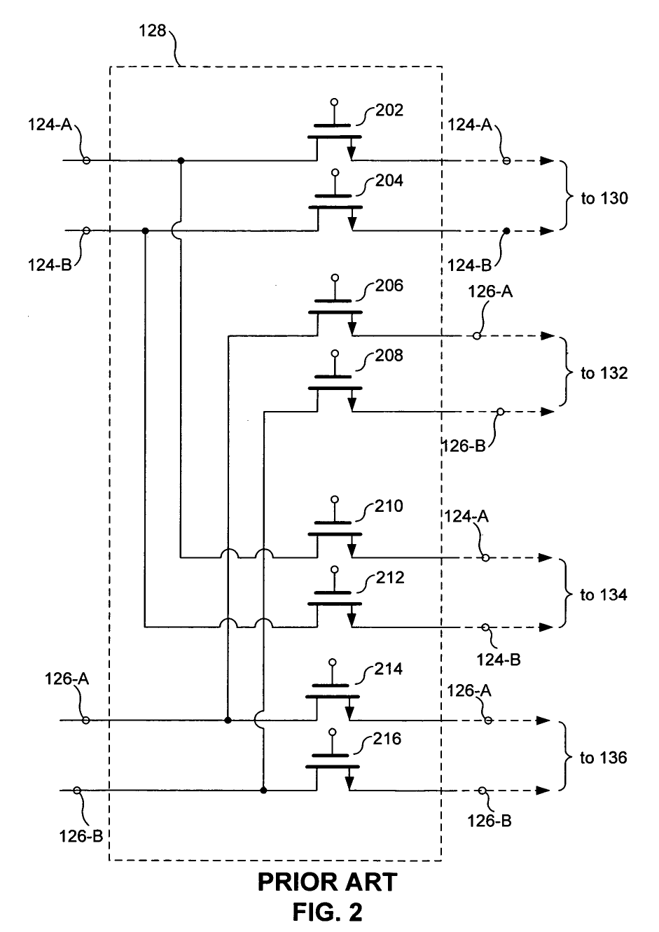

FIG. 2 illustrates a configuration of the conventional switch 128. As shown in FIG. 2, the conventional switch 128 includes eight (8) n-channel type metal oxide semiconductor field effect transistors (NFETs): NFETs 202-216. The drains of NFET 202 and NFET 210 are coupled to a first differential component of the processed modulated signal 124 (shown as 124-A). The drains of NFET 204 and NFET 212 are coupled to a second differential component of the processed modulated signal 124 (shown as 124-B). The drains of NFET 206 and NFET 214 are coupled to a first differential component of the processed modulated signal 126 (shown as 126-A). The drains of NFET 208 and NFET 216 are coupled to a second differential component of the processed modulated signal 126 (shown as 126-B).

The sources of NFET 202 and NFET 204 are coupled to the mixer 130 and the sources of NFET 206 and NFET 208 are coupled to the mixer 132. Likewise, the sources of NFET 210 and NFET 212 are coupled to the mixer 134 and the sources of NFET 214 and NFET 216 are coupled to the mixer 136. The processed modulated signal 124 is provided to the mixer 130 when the gates of the NFETs 202 and 204 are biased to turn the NFETs 202 and 204 on. Alternatively, the processed modulated signal 124 is provided to the mixer 134 when the gates of the NFETs 210 and 212 are biased to turn the NFETs 210 and 212 on. Similarly, the processed modulated signal 126 is provided to the mixer 132 when the gates of the NFETs 206 and 208 are biased to turn the NFETs 206 and 208 on. The processed modulated signal 126 is provided to the mixer 136 when the gates of the NFETs 214 and 216 are biased to turn the NFETs 214 and 216 on.

The NFETs 202-216 operate as switches to route the incoming processed modulated signals 124 and 126 to the appropriate mixer pair based on a desired transmitter operation (e.g., a mode a modulation). Proper routing is achieved by turning an appropriate portion of the NFETs 202-216 “on” and an appropriate portion of the NFETs 202-216 “off.” In this way, the conventional switch 128 enables the up-conversion of the modulated data signals 124 and 126 to either the B/G band of operation (using the mixers 130 and 132) or the A band of operation (using the mixers 134 and 136).

The switching functionality of the NFETs 202-216 can alternatively be provided by p-channel type metal oxide semiconductor field effect transistors (PFETs). Further, the switching/signal routing functionality of the conventional switch 128 can be provided using transmission gates in place of the NFETs 202-216.

The NFETs 202-216 do not operate as ideal switches. Specifically, the NFETs 202-216 add distortion to the processed modulated signals 124 and 126 during signal routing. Further, a voltage drop between the drain and source of each NFET reduces the voltage headroom of the processed modulated signals 124 and 126. Reduction in voltage headroom can lead to further distortion of the processed modulated signals 124 and 126 during signal routing. The introduction of distortion and the reduction of voltage headroom can also occur if the conventional switcher 128 is implemented with PFETs or transmission gates, as discussed above.

Therefore, what is needed is an IEEE 802.11a/b/g wireless transmitter that minimizes the introduction of distortion and the reduction of voltage headroom while providing the ability to switch between A band and B/G band operation. More broadly, a wireless transmitter that minimizes the introduction of distortion and the reduction of voltage headroom while providing synchronous or asynchronous multi-band operation is needed.

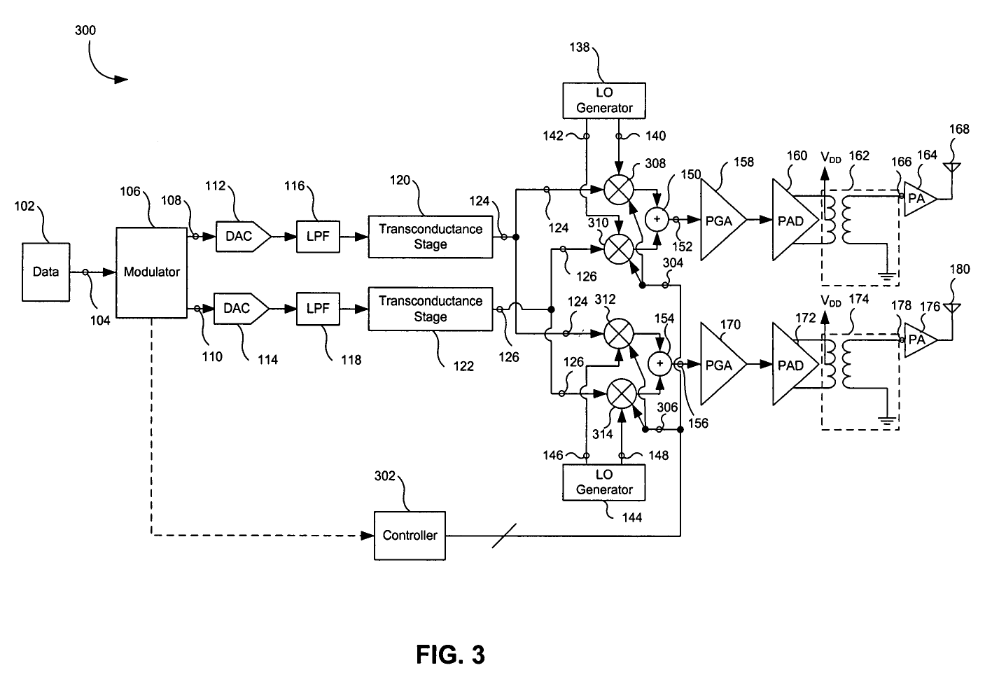

FIG. 3 illustrates a wireless transmitter 300 that minimizes the introduction of distortion and the reduction of voltage headroom while providing synchronous or asynchronous multi-band operation in accordance with an aspect of the present invention. As shown in FIG. 3, the wireless transmitter includes a controller 302. The, controller 302 is coupled to a first set of mixers (i.e., the mixers 308 and 310) and the second set of mixers (i.e., the mixers 312 and 314). The processed modulated signal 124 is directly coupled from an output of the transconductance stage 120 to the signal inputs of the mixers 308 and 312. Likewise, the processed modulated signal 126 is directly coupled from an output of the transconductance stage 122 to the signal inputs of the mixers 310 and 314.

The first set of mixers are capable of up-converting the processed modulated signals 124 and 126 to a first RF band of operation. The second set of mixers are capable of up-converting the processed modulated signals 124 and 126 to a second RF band of operation. The processed modulated signals 124 and 126 are up-converted to the first and/or second band of operation by activating or deactivating the first and second set of mixers, respectively. The first and second set of mixers are activated or deactivated by the controller 302. Specifically, the first set of mixers are controlled using a control signal 304. The second set of mixers are controlled using a control signal 306.

During operation of the wireless transmitter 300, each mixer receives a corresponding baseband or IF input signal (i.e., either the processed modulated signal 124 or 126). However, only those mixers activated by the controller 302 up-convert or frequency translate a received input signal according to a corresponding LO signal (i.e., one of the LO signals 140-148). In this way, the wireless transmitter 300 provides selectable up-conversion of an input signal without conventional signal switching or routing. In turn, the introduction of distortion and the reduction of voltage headroom to accommodate selectable multi-band operation is minimized.

The controller 302 can activate the first and second set of mixers for simultaneous multi-band operation or only one set of mixers for distinct single-band operation. Further, the controller 302 can be coupled to the modulator 106 to activate the first and/or second set of mixers based on the modulation scheme implemented by the modulator 106. That is, the controller 302 can detect a change in modulation scheme employed by the modulator 106 and accordingly adjust operation of the first and second set of mixers. Alternatively, the controller 302 can be preprogrammed or can include a memory device to dictate the activation and deactivation of the first and second set of mixers.

As shown in FIG. 3, the wireless transmitter 300 provides multi-band operation without a switch or routing system to route input signals to appropriate mixers for up-conversion. Correct routing of the input signals is achieved without the need for a switch box. In turn, design and manufacturing time is reduced. Further, area is saved when the wireless transmitter 300 is fabricated on a single chip.

The wireless transmitter 300 can be implemented as an IEEE 802.11a/b/g transmitter. To do so, the controller 302 deactivates the mixers 312 and 314 activates the mixers 308 and 310 to up-convert the processed modulated signals 124 and 126 to the B/G band of operation. Alternatively, the controller deactivates the mixers 308 and 310 activates the mixers 312 and 314 to up-convert the processed modulated signals 124 and 126 to the A band of operation. The controller 302 can change the operation band of the wireless transmitter 300 based on the modulation scheme employed by the modulator 106 (e.g., by receiving a signal indicating such a change from the modulator 106).

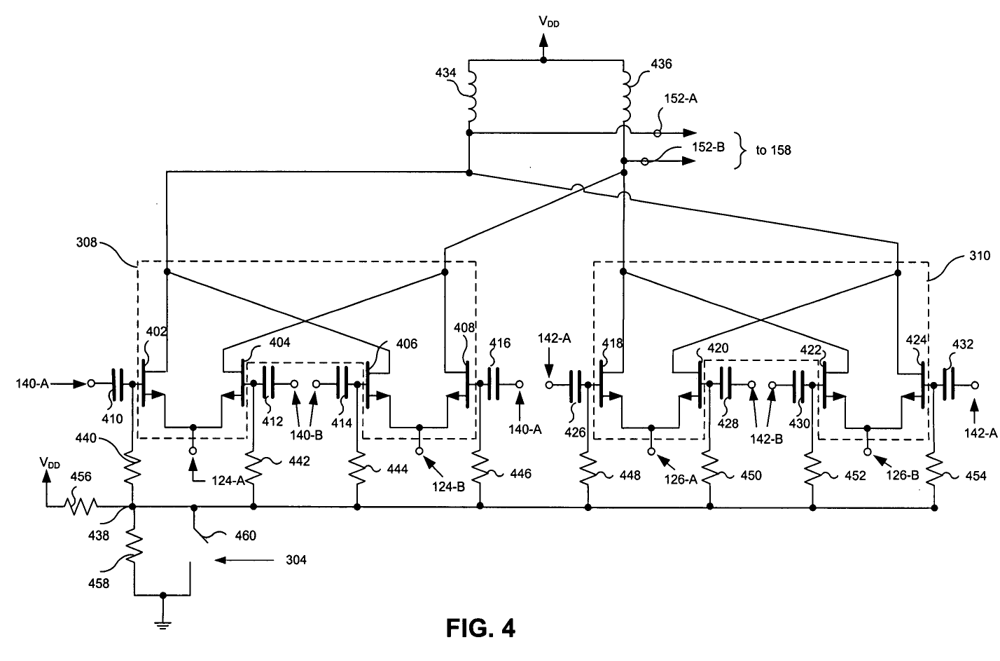

FIG. 4 illustrates a biasing arrangement of the present invention used to provide a first selectable band of operation while minimizing distortion and the reduction of voltage headroom. Specifically, FIG. 4 depicts a possible configuration and operation of the mixers 308 and 310. It is important to note that the mixers 312 and 314 can be configured in a manner similar to the configuration of the mixers 308 and 310 as shown in FIG. 4. Therefore, the discussion herein on the operation of the mixers 308 and 310 is applicable to the operation of the mixers 312 and 314.

As shown in FIG. 4, a first component of the differential processed modulated signal 124-A is provided to the sources of NFETs 402 and 404. A second component of the differential processed modulated signal 124-B is provided to the sources of NFETs 406 and 408. The gate of the NFET 402 is coupled to a first differential component of the in-phase LO signal 140 (shown as 140-A) through a capacitor 410. The gate of the NFET 404 is coupled to a second differential component of the in-phase LO signal 140 (shown as 140-B) through a capacitor 412. The gate of the NFET 406 is coupled to the second differential component of the in-phase LO signal 140-B through a capacitor 414. The gate of the NFET 408 is coupled to the first differential component of the in-phase LO signal 140-A through a capacitor 416.

The NFETs 410 and 412 form a first differential amplifier pair and the NFETs 414 and 416 form a second differential amplifier pair. Collectively, the NFETs 410, 412, 414 and 416 are arranged as a Gilbert cell and represent a possible configuration of the mixer 308. The NFETs 410, 412, 414 and 416 operate to gate the processed modulated signal 124 at the frequency of the in-phase LO signal 140, so as to up-convert or frequency translate the processed modulated signals 124-A and 124-B.

As further shown in FIG. 4, a first component of the differential processed modulated signal 126-A is provided to the sources of NFETs 418 and 420. A second component of the differential processed modulated signal 126-B is provided to the sources of NFETs 422 and 424. The gate of the NFET 418 is coupled to a first differential component of the quadrature-phase LO signal 142 (shown as 142-A) through a capacitor 426. The gate of the NFET 420 is coupled to a second differential component of the quadrature-phase LO signal 142 (shown as 142-B) through a capacitor 428. The gate of the NFET 430 is coupled to the second differential component of the quadrature-phase LO signal 142-B through a capacitor 430. The gate of the NFET 424 is coupled to the first differential component of the quadrature-phase LO signal 142-A through a capacitor 432.

The NFETs 418 and 420 form a third differential amplifier pair and the NFETs 422 and 424 form a fourth differential amplifier pair. Collectively, the NFETs 418, 420, 422 and 424 are arranged as a Gilbert cell and represent a possible configuration of the mixer 310. The NFETs 418, 420, 422 and 424 operate to gate the processed modulated signal 126 at the frequency of the quadrature-phase LO signal 142, so as to up-convert or frequency translate the processed modulated signals 126-A and 126-B.

As further shown in FIG. 4, the drains or outputs of the NFETs 402 and 406 are coupled to the drains or outputs of the NFETs 420 and 424 and applied to an inductive load 434. The inductive load 434 is coupled to a voltage supply V_{DD} and represents a portion of the differential load representing the remaining sections of the wireless transmitter 300 (e.g., the PGA 158, the PAD 160, the transformer 162, the PA 164 and the antenna 168). Connecting the outputs of the NFETs 402, 406, 420 and 424 in this way implements a portion of the inverting summer 150. The outputs of the NFETs 402, 406, 420 and 424 combine corresponding differential in-phase and quadrature-phase components and produce a first differential component of the first up-converted modulated signal 152 (shown as 152-A).

In a similar manner, the drains or outputs of the NFETs 404 and 408 are coupled to the drains or outputs of the NFETs 418 and 422 and applied to an inductive load 436. The inductive load 436 is coupled to the voltage supply V_{DD} and represents a portion of the differential load representing the remaining sections of the wireless transmitter 300 (e.g., the PGA 158, the PAD 160, the transformer 162, the PA 164 and the antenna 168). Connecting the outputs of the NFETs 404, 408, 418 and 422 in this way implements a portion of the inverting summer 150. The outputs of the NFETs 404, 408, 418 and 422 combine corresponding differential in-phase and quadrature-phase components and produce a second differential component of the first up-converted modulated signal 152 (shown as 152-B). The NFETs 402-408 and 418-422 can alternatively be connected to implement a non-inverting summer to produce the output signals 152-A/B (with the according changes to the polarities of the input signals 124-A/B and 126-A/B).

The gate of the NFET 402 is coupled to a node 438 through a resistor 440. Further, the gates of the NFETs 404, 406 and 408 are coupled to the node 438 through resistors 442, 444 and 446, respectively. Similarly, the gates of the NFETs 418, 420, 422 and 424 are coupled to the node 438 through resistors 448, 450, 452 and 454, respectively. A resistor 456 is coupled between the node 438 and the voltage supply V_{DD}. A ground is coupled to the node 438 through a resistor 458. Further, a switch 460 is coupled between the node 438 and the ground. The switch is controlled by the control signal 304 provided by the controller 302. The resistors 440-454, 456 and 458 are configured as a resistive network for the mixers 308 and 310. The resistor network is coupled to a bias voltage V_{BIAS} at the node 438 provided by the power supply V_{DD}. Collectively, the power supply V_{DD}, the resistor network, the bias voltage V_{BIAS}, and the switch 460 form a bias network for the mixer 308 and 310.

When the switch 460 is deactivated (i.e., open), a portion of the bias voltage V_{BIAS} is applied to each of the gates of the NFETs 402-408 and the NFETs 418-424. Consequently, the NFETs 402-408 and the NFETs 418-424 are turned on. In turn, the mixers 308 and 310 are activated such that the processed modulated signals 124 and 126 are up-converted by the in-phase LO signal 140 and the quadrature-phase LO signal 142, respectively. In essence, operation on the band provided by the LO generator 138 is selected by deactivating the switch 460.

When the switch 460 is activated (i.e., closed), a portion of the bias voltage V_{BIAS} is not provided to any of the gates of the NFETs 402-408 and the NFETs 418-424. That is, each of the gates of the NFETs 402-408 and the NFETs 418-424 are shorted to ground. The power supply voltage V_{DD} is therefore dissipated across the resistor 456 and the node 438 becomes a ground. Consequently, the NFETs 402-408 and the NFETs 418-424 are turned off. In turn, the mixers 308 and 310 are deactivated such that the processed modulated signals 124 and 126 are not up-converted by the in-phase LO signal 140 and the quadrature-phase LO signal 142, respectively. The NFETs 402-408 and the NFETs 418-424 appear as high impedance devices (between the drain and source terminals) when turned off such that the processed modulated signals 124 and 126 have no path to the outputs of the mixers 308 and 310, respectively. Overall, operation on the band provided by the LO generator 138 is blocked by activating the switch 460.

The switch 460 can be implemented using a variety of circuit devices including, for example, an NFET, a PFET or a transmission gate. Further, it will be appreciated by one skilled in the pertinent art(s) that the mixers 308 and 310 can be modified to use PFETs in place of the NFETs 402-408 and NFETs 418-424 without departing from the scope and spirit of the present invention.

Further, other biasing techniques can be used to activate and deactivate component mixers without departing from the spirit and scope of the present invention. For instance, a bias voltage can be applied to the sources of the FETs 402-408 and the FETs 418-424 to turn the FETs on and off.

To provide selectable multi-band operation, the wireless transmitter 300 provides a high impedance path for input signals to prevent up-conversion (when corresponding component mixers are not biased—gates shorted to a ground through a switch) and provides a reduced impedance path for input signals to enable up-conversion (when corresponding component are biased—gates connected to a bias voltage). In this way, the wireless transmitter 300 can provide synchronous or asynchronous multi-band transmitter operation by appropriately biasing LO inputs of component mixers. Therefore, single band operation as well as simultaneous multi-band operation is provided in accordance with an aspect of the present invention.

Further, it will be appreciated by one skilled in the pertinent art(s) that the direct activation of mixers to enable selectable multi-band operation provided by the present invention is not limited to the embodiment depicted in FIG. 3. Specifically, the direct activation of mixers to enable selectable multi-band operation provided by an aspect of the present invention can be used in a transmitter receiving multiple input signals and using multiple mixers to provide operation on multiple RF bands. Overall, the present invention is scalable and flexible and therefore applicable to multiple transmitter designs (e.g., I/Q transmitters, single-phase transmitters, differential or single-ended transmitters, transmitters using multiple mixers per band, transmitters having synchronous or asynchronous multi-band operation).

It will be appreciated by one skilled in the pertinent art(s) that the mixers 308 and 310 as depicted in FIG. 4 can be modified to provide selectable down-conversion of input signals without departing from the scope and spirit of the present invention. That is, the selective activation of a mixer to frequency translate an input signal according to an associated LO signal provided by an aspect of the present invention is generally applicable to a wireless receiver. Specifically, an aspect of the present invention provides selective down-conversion of an input signal (e.g., an RF input signal) using multiple mixers. In this way, an aspect of the present invention enables multiple RF input signals to be down-converted to one or more baseband or IF bands in a synchronous or asynchronous manner. Selective down-conversion can be based on a frequency of an RF input signal.

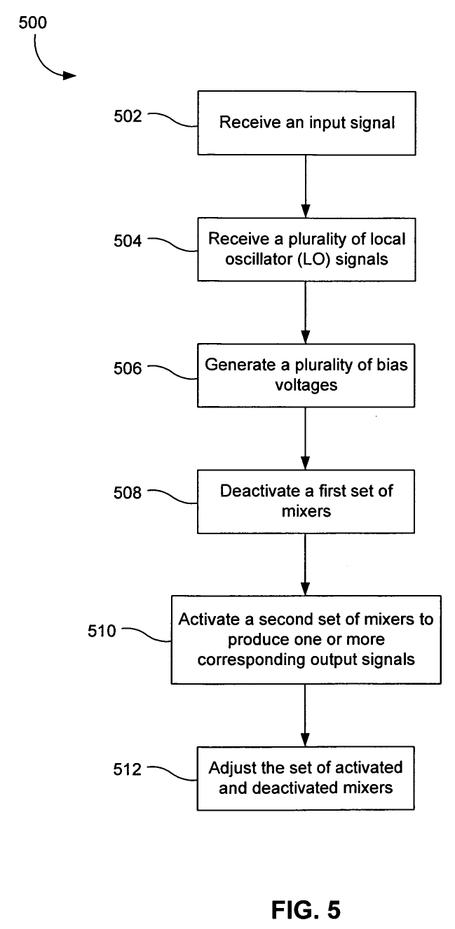

FIG. 5 provides a flowchart 500 that illustrates operational steps for selectively frequency translating an input signal in accordance with an aspect of the present invention. The invention is not limited to this operational description. Rather, it will be apparent to persons skilled in the relevant art(s) from the teachings herein that other operational control flows are within the scope and spirit of the present invention. In the following discussion, the steps in FIG. 5 are described.

At step 502, an input signal is received. The input signal can be a baseband signal, an IF signal or an RF signal.

At step 504, a plurality of LO signals are received. Each LO signal and the input signal are coupled to a corresponding mixer. That is, each mixer receives the input signal and a corresponding LO signal.

At step 506, a plurality of bias voltages are generated. A bias voltage is generated or provided for each mixer. A common bias voltage can be distributed to each mixer using a bias network of each mixer such that each mixer is effectively provided a bias voltage.

At step 508, a first set of mixers is deactivated. Specifically, the corresponding bias voltages are removed or decoupled from each mixer within the first set of mixers. In essence, the bias voltages are shorted to a ground through a switch. As a result, each mixer in the first set of mixers provides a high impendence path for the received input signal. Each mixer in the first set of mixers therefore does not frequency translate the input signal according to its corresponding LO signal.

At step 510, a second set of mixers is activated. Specifically, the corresponding bias voltages are coupled to each mixer within the second set of mixers. As a result, each mixer in the second set of mixers frequency translates the input signal according to its corresponding LO signal. In turn, one or more corresponding output signals are produced. The activated mixers can provide up-conversion or down-conversion based on a frequency of the input signal and a frequency of each corresponding LO signal. Generally, a baseband input signal is up-converted to produce an RF output signal while an RF input signal is down-converted to produce a baseband output signal.

Step 512 depicts the continuous adjustment of the set of activated and deactivated mixers. The mixers can be adjusted by a controller. During operation, any number of mixers can be activated or deactivated.

### CONCLUSION

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A frequency translation apparatus, comprising:
a plurality of mixers, each mixer coupled to an input signal and a corresponding local oscillator (LO) signal; and
a plurality of bias networks corresponding to the plurality of mixers to produce a bias voltage for a corresponding mixer;
wherein the bias voltage of at least one bias network is applied to the corresponding mixer to frequency translate the input signal according to the corresponding LO signal, thereby producing at least one output signal.

2. The frequency translation apparatus of claim 1, wherein the input signal a baseband input signal.

3. The frequency translation apparatus of claim 2, wherein the at least one output signal is a radio frequency (RF) output signal.

4. The frequency translation apparatus of claim 1, wherein the input signal a radio frequency (RF) signal.

5. The frequency translation apparatus of claim 2, wherein the at least one output signal is a baseband output signal.

6. The frequency translation apparatus of claim 1, further comprising a controller to apply the bias voltage of the at least one bias network to the corresponding mixer.

7. The frequency translation apparatus of claim 6, wherein the controller applies the bias voltage of the at least one bias network to the corresponding mixer based on a modulation type of the input signal.

8. The frequency translation apparatus of claim 6, wherein the controller applies the bias voltage of the at least one bias network to the corresponding mixer based on a frequency of the input signal.

9. The frequency translation apparatus of claim 1, wherein the input signal is a differential input signal.

10. The frequency translation apparatus of claim 1, wherein each bias network comprises:
a resistor network coupled to a supply voltage; and
a switch coupled to the resistor network and coupled between an input of the corresponding mixer and a ground.

11. The frequency translation apparatus of claim 10, wherein the switch is activated to short the bias voltage to the ground, thereby removing the bias voltage from the corresponding mixer.

12. The frequency translation apparatus of claim 10, wherein the switch is deactivated to apply the bias voltage to the input of the corresponding mixer.

13. A method for frequency translating an input signal, comprising:
receiving an input signal;
receiving a plurality of local oscillator (LO) signals, each LO signal and the input signal coupled to a corresponding mixer within a plurality of mixers;
generating a plurality of bias voltages corresponding to the plurality of mixers;
deactivating a first set of mixers within the plurality of mixers; and
activating a second set of mixers within the plurality of mixers, thereby frequency translating the input signal according to corresponding LO signals of the second set of mixers to produce one or more corresponding output signals.

14. The method of claim 13, wherein receiving the input signal comprises receiving a baseband input signal.

15. The method of claim 13, wherein receiving the input signal comprises receiving a radio frequency (RF) input signal.

16. The method of claim 13, wherein deactivating comprises shorting each of the plurality of the bias voltages corresponding to the first set of mixers to a ground.

17. The method of claim 16, wherein shorting comprises activating a switch.

18. The method of claim 13, wherein activating comprises applying each of the plurality of the bias voltages corresponding to the second set of mixers to an input of each of the second set of mixers.

19. The method of claim 18, wherein applying comprises deactivating a switch.

20. A frequency translation apparatus, comprising:
a plurality of mixers, each mixer coupled to an input signal and a corresponding local oscillator (LO) signal;
means for producing a corresponding bias voltage for each mixer; and
means for selectively applying the corresponding bias voltage for at least one mixer to an input of the at least one mixer to frequency translate the input signal according to the corresponding LO signal, thereby producing an output signal.
